(19) United States
(12) Patent Application Publication
(10) Pub. No.: US 2025/0002310 A1
(43) Pub. Date: Jan. 2, 2025

(54) Wheel Component Handling Device

(71) Applicant: Prowse Holdings Pty Ltd, Gledhow (AU)

(72) Inventor: David Slee, Gledhow (AU)

(21) Appl. No.: 18/755,481

(22) Filed: Jun. 26, 2024

(30) Foreign Application Priority Data
Jun. 28, 2023 (AU) 2023902037

(51) Int. Cl. B66F 5/00

(52) U.S. Cl. CPC B66F 5/00

(57) ABSTRACT

A wheel component handling (10) device comprising a frame (12) having a plurality of wheels (24). A support shaft (14) extends upwardly from the rear of the frame (12) adjacent a first side (22). A support arm (16) is pivotally mounted at a first end thereof to the support shaft (14) to rotate through a vertical plane and a lifting device (40) is secured to the rear of the frame (12) to engage with the support arm (16) adjacent the first end. A component support (18) is secured to second end of the support arm (16). The component support (18) has a mount for holding a component of a wheel, the mount being located between the first and second ends of the support arm (16) on a side of the support arm (16) facing the second side of the frame (12).

### FIELD OF THE INVENTION

The present invention relates to a device for supporting and maneuvering a component of a wheel, such as a wheel hub

### BACKGROUND TO THE INVENTION

Components of vehicle wheels require regular maintenance, which will often require removal of the components from the vehicle. In the case of large vehicles, such as trucks, these components can be extremely heavy, making the process of removing and positioning the component for maintenance difficult.

The present invention relates to an apparatus constructed to allow components of wheels such as wheel hubs to be supported and maneuvered for servicing, as well as replacement. The wheel component handling device is designed to be simple to use, inexpensive to produce and sufficiently strong to work with components of large vehicles.

### SUMMARY OF THE INVENTION

According to one aspect of the present invention there is provided a wheel component handling device comprising:
a frame having a plurality of wheels to rest on the ground, the frame having a front, a rear, a first side and a second side;
a support shaft extending upwardly from the rear of the frame adjacent the first side;
a support arm pivotally mounted at a first end thereof to the support shaft to rotate through a vertical plane, the support arm extending forwardly from the support shaft;
a lifting device secured to the rear of the frame to engage with the support arm adjacent the first end thereof; and
a component support secured to second end thereof;
wherein the component support has a mount for holding a component of a wheel, the mount being located between the first and second ends of the support arm on a side of the support arm facing the second side of the frame.

Preferably the component support includes a tool arm having a first end rotatably secured to the second end of the support arm and a second end located below the support arm and between the first and second ends thereof.

Preferably the component support includes a post secured to the second end of the tool arm extending upwardly therefrom.

Preferably the tool arm is formed from a flat bar oriented in a vertical plane and includes one or more holes for receiving a locking pin to fix the position of the tool arm relative to the support arm.

Preferably the mount comprises a lower mount arm fixed to the post and an upper mount arm slidably connected to the post, the lower mount arm including an aperture adjacent a distal end thereof and the upper arm including a slot on a lower side thereof.

Preferably the frame comprises parallel first and second side members connected together by a rear member.

In a preferred embodiment, each of the first and second side members and the rear member comprises a tubular member.

Preferably a lower end of the support shaft is secured to an end of the rear member adjacent the first side member.

Preferably a strut is provided extending between an outer side of the support shaft and an inner side of the first side member.

Preferably the first end of the support arm is pivotally mounted to an inner side of the support shaft and is mounted to rotate in a vertical plane.

Preferably the support arm is provided with a link member also pivotally mounted to the support shaft such that the link member is mounted above the support arm and an interconnecting member extends between distal ends of the link member and the support arm.

Preferably each of the support arm, link member and the connecting member are formed from a flat bar oriented in a vertical plane.

In a preferred embodiment, the support arm is provided also with a brace member comprising a flat bar secured to an outer side of the support arm oriented transversely to the support arm.

Preferably the lifting device comprises a jack, a lower end of which is mounted to an upper surface of the rear member adjacent the lower end of the support shaft and an upper end of a piston of the jack being engaged with a pin extending outwardly from an inner side of the support arm adjacent the first end thereof.

### BRIEF DESCRIPTION OF THE DRAWINGS

The invention will now be described, by way of example, with reference to the following drawings, in which:

FIG. 1a is a first front upper perspective view of a wheel component handling device in accordance with the present invention;

FIG. 1b is a first rear upper perspective view of the wheel component handling device of FIG. 1a;

FIG. 2a is a second front upper perspective view of the wheel component handling device of FIG. 1;

FIG. 2b is a second rear upper perspective view of the wheel component handling device of FIG. 1;

FIG. 3a is a front upper perspective view of the wheel component handling device of FIG. 1 supporting a wheel hub;

FIG. 3b is a rear upper perspective view of the wheel component handling device of FIG. 1 supporting the wheel hub;

FIG. 4a is a first side view of the wheel component handling device of FIG. 1;

FIG. 4b is a front view of the wheel component handling device of FIG. 1;

FIG. 4c is a second side view of the wheel component handling device of FIG. 1;

FIG. 5a is a bottom view of the wheel component handling device of FIG. 1;

FIG. 5b is a rear view of the wheel component handling device of FIG. 1; and

FIG. 5c is a top view of the wheel component handling device of FIG. 1.

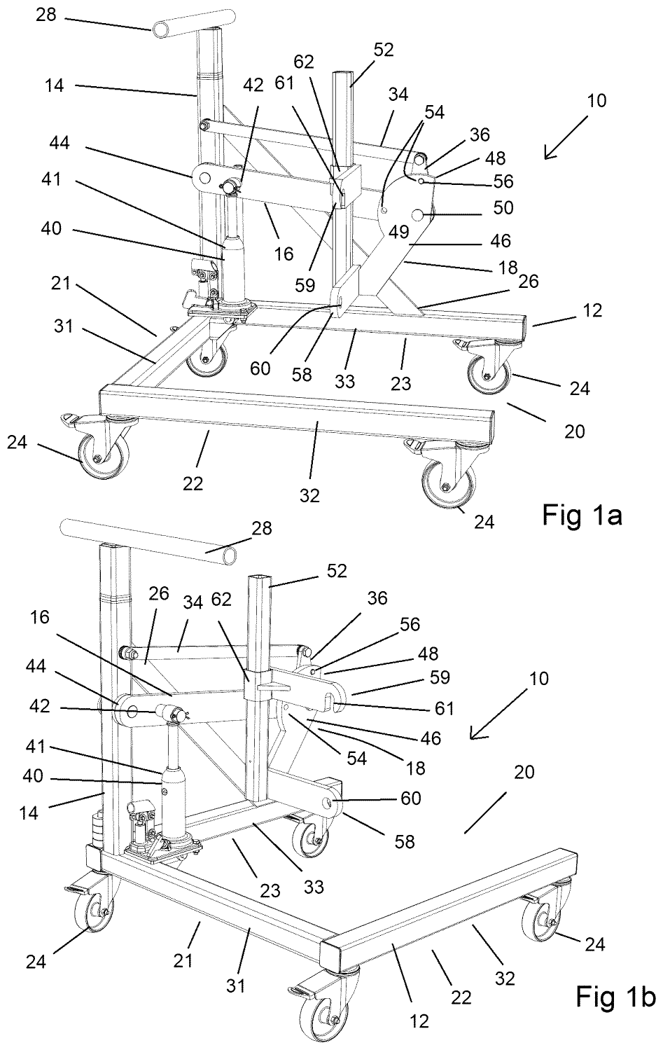

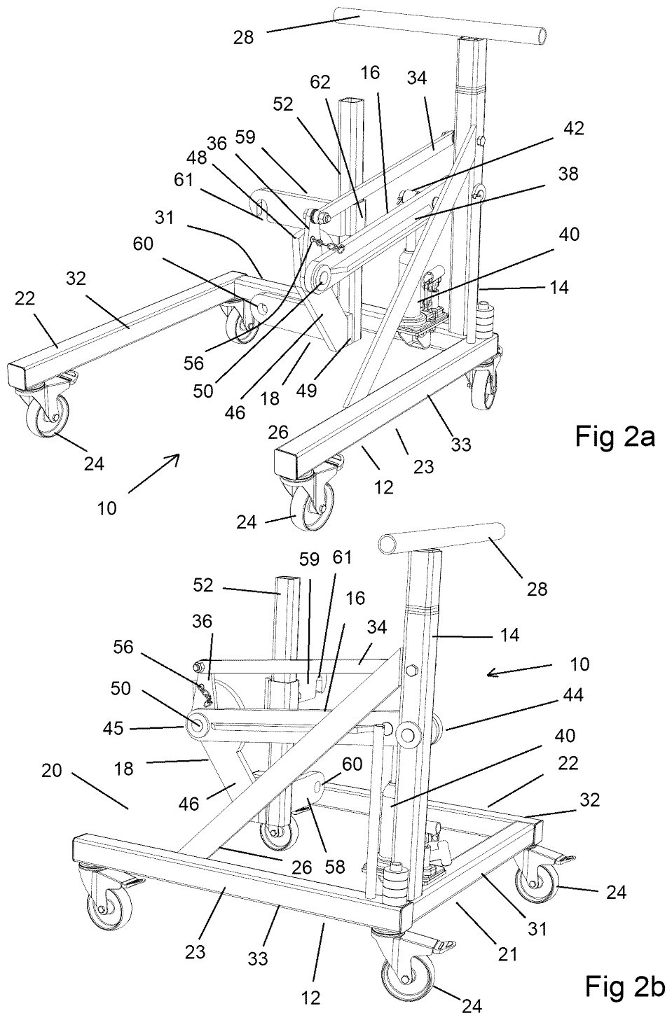

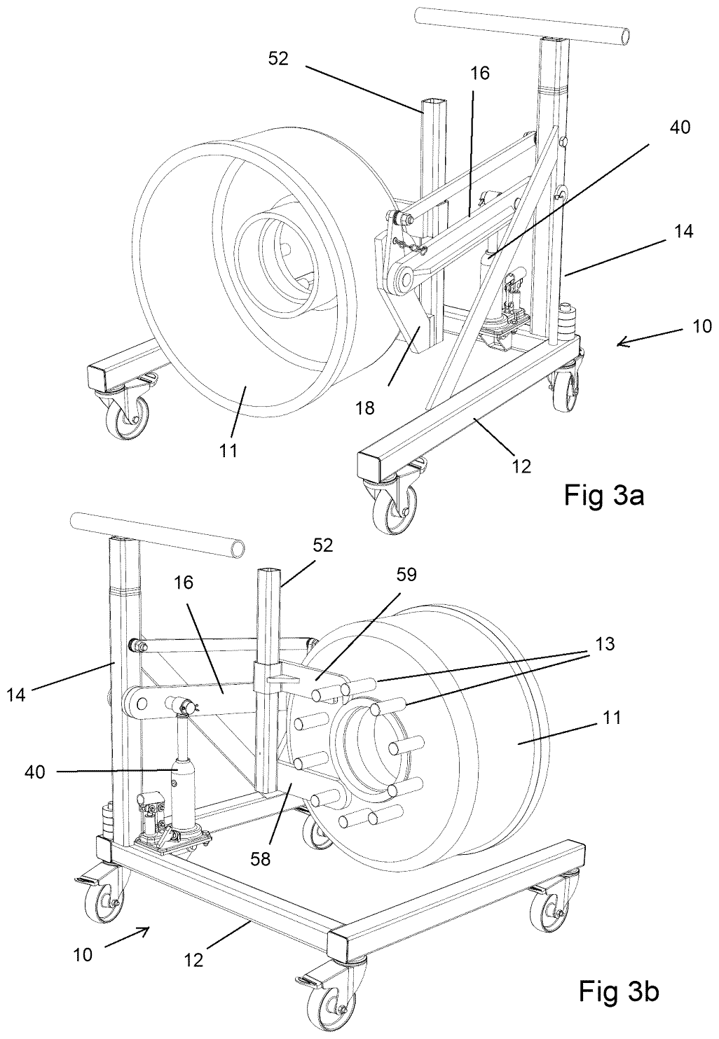

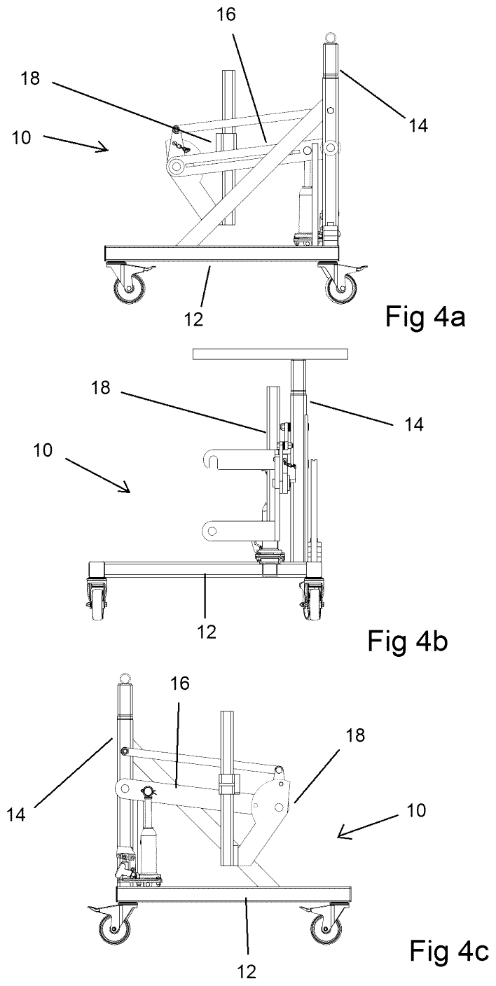

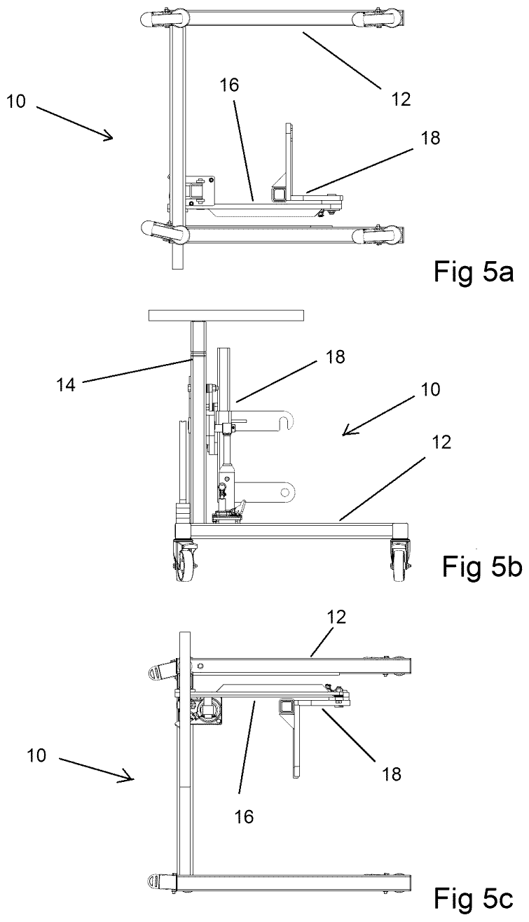

### DETAILED DESCRIPTION OF PREFERRED EMBODIMENTS

Referring to the Figures, there is shown a wheel component handling device 10 comprising generally a frame 12 and a support shaft 14 extending upwardly from the frame 12. The wheel component handling device 10 includes also a support arm 16 extending outwardly from the support shaft 14 and a component support 18 mounted to a distal end of the support arm 16.

The frame 12 comprises generally a front 20, a rear 21, a first side 22, and a second side 23. The frame 12 in the embodiment shown comprises a first side member 32, a second side member 33 and a rear member 31. The first and second side members 32 and 33 are parallel to each other and the rear member 31 extends between rear ends of the first and second side members 32 and 33. Each of the first and second side members 32 and 33 and the rear member 31 comprises a tubular member of a suitable material, such as a steel, having a rectangular cross-section. The frame 12 is therefore U-shaped in the embodiment shown being open at the front 20.

The frame 12 is provided with a plurality of wheels 24 mounted to a lower side thereof. In the embodiment shown, there are provided wheels 24 mounted to both the front and rear ends of the first and second side members 22 and 23. The frame 12 may therefore be moved around to both engage with a component of a wheel and to then move the component to a suitable location to work on the wheel from which the component is removed, or the component itself.

The support shaft 14 extends upwardly from the rear 21 of the frame 12 adjacent the first side 22. The support shaft 14 in the embodiment shown comprises a tubular member of a suitable material, such as steel, having a rectangular cross-section. A lower end of the support shaft 14 is secured by suitable means, such as welding, to an end of the rear member 31 adjacent the first side member 32. A strut 26 is provided extending between the support shaft 14 and the first side member 22. A first end of the strut 26 is attached to an outer side of the support shaft 14 (being a side adjacent the first side member 32) between upper and lower ends thereof and a second end of the strut 26 is attached to an inner side of the first side member 32 (being a side facing the second side member 33) between front and rear ends thereof. The strut 26 comprises a flat bar oriented in a vertical plane secured to the support shaft 14 and the first side member 32 by appropriate means, such as bolts and/or welding.

The support shaft 14 is provided with a handle 28 on an upper end thereof. In the embodiment shown, the handle 28 comprises an elongate member secured to the upper end of the support shaft 14 transversely to the support shaft 14.

The support arm 16 includes a first end 44 pivotally mounted to the support shaft 14 and a second end 45 extending forwardly of the support shaft 14. The first end 44 of the support arm 16 is pivotally mounted to an inner side of the support shaft 14 (being the side facing the second side member 33) and is mounted to rotate in a vertical plane. The support arm 16 is provided with a link member 34 also pivotally mounted to the support shaft 14 such that the link member 34 is mounted above the support arm 16. An interconnecting member 36 extends between a distal end of the link member 34 and the second end 45 of the support arm 16 and is pivotally mounted to both the link member 34 and the interconnecting member 36 such that the link member 34 and the support arm 16 are parallel to each other and may pivot together through a vertical plane.

Each of the support arm 16, the link member 34 and the connecting member 36 are formed from a flat bar oriented in a vertical plane of a suitable material, such as steel. The support arm 16 is provided also with a brace member 38. The brace member 38 comprises a bar secured to an outer side of the support arm 16 transversely to the support arm 16 by suitable means, such as welding.

The wheel component handling device 10 is provided also with a lifting device 40 connected to the frame 12. The lifting device 40 is secures to the frame 12 and includes an upper end to engage with the support arm 16 in order to raise or lower the support arm 16. In the embodiment shown, the lifting device 40 comprises a jack 41, a lower end of which is mounted to an upper surface of the rear member 31 adjacent the lower end of the support shaft 14. An upper end of a piston of the jack 41 engages with a pin 42 extending outwardly from an inner side of the support arm 16 adjacent the first end 44 thereof. Operation of the jack 41 thereby applies a lifting force to the support arm 16 to raise the second end 45 of the support arm 16.

The component support 18 includes a tool arm 46 having a first end 48 secured to the second end 45 of the support arm 16. The first end 48 of the tool arm 46 is rotatably connected to the support arm 16 and in the embodiment shown is connected to the pivot pin 42 extending through both the interconnecting member 36 and the support arm 16. The tool arm 46 is oriented such that a second end 49 thereof is located below the support arm 16 and generally between the first and second ends 44 and 45 thereof. That is, the tool arm 46 extends from the first end 48 downwardly and back towards the support shaft 14. The component support 18 is provided also with a post 52 secured to the second end 49 of the tool arm 46 by appropriate means, such as welding. The post 52 extends upwardly from the second end 49 of the tool arm 46.

The tool arm 46 is formed from a flat bar in the embodiment shown and is oriented in a generally vertical plane and includes one or more holes 54 alignable with a hole provided on the interconnecting member 36. A locking pin 56 may be passed through the hole in the interconnecting member 36 and one of the holes 54 on the tool arm 46 to place the tool arm 46 and therefore the post 52 in the desired orientation.

The support shaft 14 includes a mount extending outwardly therefrom provided to engage with a component of the wheel. In the embodiment shown, the mount comprises a lower mount arm 58 and an upper mount arm 59. The lower mount arm 58 extends outwardly from a lower end of the post 52 and is fixed relative thereto. The lower mount arm 58 extends generally parallel to the rear member 31 includes an aperture 60 in a distal end thereof. The upper mount arm 59 includes a collar at a first end into which the post 52 may be slidably received such that the upper mount arm 59 may slide up and down relative to the post 52. The upper mount arm 59 includes a slot 61 in a lower side thereof adjacent the distal end. Both the upper and lower mount arms 58 and 59 comprise a flat bar oriented in a generally vertical plane.

In use, the wheel component handling device 10 may be rolled into a location adjacent the component, such as a wheel hub 11, which is to be supported. The component support 18 is moved into the correct vertical position by operation of the lifting device 40 to engage with the hub 11. The aperture 60 in the lower mount arm 58 can engage over one of the studs 13 in the hub 11 and the upper mount arm 59 slides downwardly to engage onto another of the studs 13. The hub 11 is then securely engaged with the component support 18 and may be moved away from the vehicle to which the hub 11 has been fitted to provide access for maintenance.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A wheel component handling device comprising:
a frame having a plurality of wheels to rest on the ground, the frame having a front, a rear, a first side and a second side;
a support shaft extending upwardly from the rear of the frame adjacent the first side;
a support arm pivotally mounted at a first end thereof to the support shaft to rotate through a vertical plane, the support arm extending forwardly from the support shaft;
a lifting device secured to the rear of the frame to engage with the support arm adjacent the first end thereof; and
a component support secured to second end thereof;
wherein the component support has a mount for holding a component of a wheel, the mount being located between the first and second ends of the support arm on a side of the support arm facing the second side of the frame.

16. The wheel component handling device in accordance with claim 15, wherein the component support includes a tool arm having a first end rotatably secured to the second end of the support arm and a second end located below the support arm and between the first and second ends thereof.

17. The wheel component handling device in accordance with claim 16, wherein the component support includes a post secured to the second end of the tool arm extending upwardly therefrom.

18. The wheel component handling device in accordance with claim 15, wherein the tool arm is formed from a flat bar oriented in a vertical plane and includes one or more holes for receiving a locking pin to fix the position of the tool arm relative to the support arm.

19. The wheel component handling device in accordance with claim 15, wherein the mount comprises a lower mount arm fixed to the post and an upper mount arm slidably connected to the post, the lower mount arm including an aperture adjacent a distal end thereof and the upper arm including a slot on a lower side thereof.

20. The wheel component handling device in accordance with claim 15, wherein the frame comprises parallel first and second side members connected together by a rear member.

21. The wheel component handling device in accordance with claim 20, wherein each of the first and second side members and the rear member comprises a tubular member.

22. The wheel component handling device in accordance with claim 20, wherein a lower end of the support shaft is secured to an end of the rear member adjacent the first side member.

23. The wheel component handling device in accordance with claim 22, wherein a strut is provided extending between an outer side of the support shaft and an inner side of the first side member.

24. The wheel component handling device in accordance with claim 20, wherein the first end of the support arm is pivotally mounted to an inner side of the support shaft and is mounted to rotate in a vertical plane.

25. The wheel component handling device in accordance with claim 24, wherein the support arm is provided with a link member also pivotally mounted to the support shaft such that the link member is mounted above the support arm and an interconnecting member extends between distal ends of the link member and the support arm.

26. The wheel component handling device in accordance with claim 25, wherein each of the support arm, link member and the connecting member are formed from a flat bar oriented in a vertical plane.

27. The wheel component handling device in accordance with claim 26, wherein the support arm is provided also with a brace member comprising a bar secured to an outer side of the support arm oriented transversely to the support arm.

28. The wheel component handling device in accordance with claim 20, wherein the lifting device comprises a jack, a lower end of which is mounted to an upper surface of the rear member adjacent the lower end of the support shaft and an upper end of a piston of the jack being engaged with a pin extending outwardly from an inner side of the support arm adjacent the first end thereof.
